(19) United States
(12) Patent Application Publication
(10) Pub. No.: US 2009/0008212 A1
(43) Pub. Date: Jan. 8, 2009

(54) Double Wet Clutch for Hybrid Traction Chain and Cooling Method

(75) Inventors: Emmanuel Combes, Saint-Cyr-sous-Dourdan (FR); Jerome Victor, Sartrouville (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/570,017

(22) PCT Filed: May 31, 2005
(86) PCT No.: PCT/FR2005/050392

§ 371 Date: Sep. 16, 2008

(30) Foreign Application Priority Data
Jun. 3, 2004 (FR) 0406023

(51) Int. Cl. F16D 13/72

(52) U.S. Cl. 192/113.34

(57) ABSTRACT

The invention concerns an element comprising an electrical machine (31), two wet clutches (33, 35), a cooling fluid circuit, including a chamber (53) for cooling the clutches (33, 35), a fluid tank (251), and a pump (255). The pump (225) is connected to a recycling channel (259), the cooling circuit comprising selecting means (257) arranged upstream of the pump (255), such that said pump is capable of selectively feeding said chamber (53) from the tank (251) and from the recycling channel (259) based on the temperature of the fluid passing through the selecting means (257). The invention also concerns an associated cooling and/or lubricating, and clutch control method, as well as a motor vehicle equipped with such a transmission document.

The present invention concerns a transmission element for a traction chain of the parallel hybrid type, said element comprising a movement input shaft intended to be connected to a thermal engine, a movement output shaft intended to be connected to a gear box, an electrical machine comprising a stator and a rotor, a first connecting clutch between the input shaft and the rotor, and a second connecting clutch between the rotor and the output shaft, said clutches being of the wet type, said transmission element further comprising a circuit of lubrication and/or cooling fluid, which comprises a lubrication and/or cooling chamber of the clutches and of the electrical machine, a tank of lubrication and/or cooling fluid, and at least one pump connected, on the one hand, to said tank, and on the other hand, to said chamber.

By parallel hybrid traction chain, it is meant a traction chain providing to a wheel shaft a mechanical energy from at least one engine of the “irreversible” type (in general, a thermal engine) and at least one engine of the “reversible” type (in general, an electrical machine, which will be designated in the following by the term “the electric motor,” it being understood that this “motor” can operate according to a motor mode and a generator mode), and in which the energy node coming from these two engines has a mechanical nature.

A transmission element of the above type is described, for example, in the French patent application FR 2 814 121.

The known transmission element of this type are equipped in general with a lubrication and/or cooling circuit in which the fluid follows an invariable path: the supply of fluid to the lubrication and/or cooling chamber is performed from the tank, the fluid extracted from the lubrication and/or cooling chamber being recycled into the tank. The latter plays the role of heat exchanger and makes it possible to cool the recycled fluid.

Such a design of the lubrication and/or cooling circuit is not fully satisfactory, in particular because it does not make it possible, in the case where the vehicle is started cold, to reach quickly the optimal operation temperature of the fluid that makes it possible to minimize the losses through friction among the moving mechanical parts.

An objective of the invention is to remedy this drawback, and to propose a transmission element of the above type, in which the lubrication and/or cooling fluid circulating in the lubrication and/or cooling chamber can reach quickly its nominal operation temperature, from a lower starting temperature.

To this effect, in a transmission element conform to the invention, said pump is further connected to a recycling channel of said chamber, the lubrication and/or cooling circuit comprising selection means placed upstream of the pump, so that said pump is capable of supplying said chamber with pressurized fluid selectively from the tank and from the recycling channel, as a function of the temperature of the fluid transiting via the selection means.

According to other characteristics of the invention, taken alone or according to all combinations that can be envisioned technically:

the selection means have two fluid inputs, among which a first input is connected to the tank and the second input is connected to the recycling channel, and a fluid output connected to the pump, the selection means operating such that, in operation of the transmission element,

the total flow rate of fluid transiting via the output of the selection means is substantially constant, and

over a temperature range of the fluid transiting via the selection means, comprised between a lower threshold value and an upper threshold value, the flow rate of fluid coming from the second input increases when the temperature decreases;

the selection means comprise a thermostatic valve;

the lubrication and/or cooling chamber of the clutches constitutes also a lubrication and/or cooling chamber of the electric motor, so that the lubrication and/or cooling circuit of the clutches constitutes also a lubrication and/or cooling circuit of the electric motor;

the transmission element further comprises control means of said clutches, which comprise a hydraulic control circuit including a pressure chamber for each clutch, such that the pressure of control fluid which prevails in the pressure chamber determines the state of the respective clutch, and the control fluid is constituted by the lubrication and/or cooling fluid, the control circuit and the lubrication and/or cooling circuit having in common at least said tank (251), said recycling channel, and said selection means;

the hydraulic control circuit comprises a distribution block connected to the pump downstream of the latter and adapted to distribute the fluid to the pressure chambers;

said control circuit comprises a pressure accumulator, and the distribution block comprises an input/output path connected to said accumulator, and a charge/discharge electrovalve assigned to said output/input path;

the distribution block comprises a control output path for each pressure chamber, and a respective electrovalve for control of the control flow rate, assigned to each of said control paths;

said control electrovalves are of the proportional type;

the transmission element comprises a second pump, connected, upstream, to the output of the selection means, and downstream, via a lubrication and/or cooling output path, to the lubrication and/or cooling chamber.

Another objective of the invention is a method of lubricating and/or cooling (and optionally control) clutches of a transmission element such as described above, comprising:

supplying the lubrication and/or cooling chamber, and optionally the pressure chambers, with a total flow rate of fluid at the output of the selection means resulting from a first flow rate of fluid coming from the first input and a second flow rate of fluid coming from the second input, such that said first and second flow rates are determined as a function of the temperature of the fluid transiting via the selection means.

Preferably:

the total flow rate of fluid transiting via the output of the selection means is substantially constant, and

over a temperature range of the fluid transiting via the selection means, comprised between a lower threshold value and an upper threshold value, the flow rate of fluid coming from the second input increases when the temperature decreases.

Finally, an object of the present invention is a motor vehicle comprising a transmission element such as described above.

A particular embodiment of the invention will now be described in more details in reference to the annexed drawings, in which:

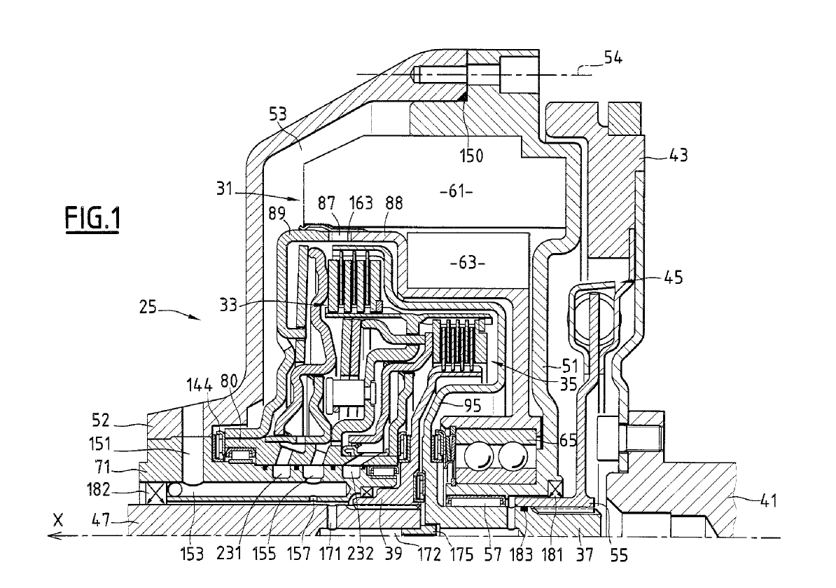

FIG. 1 is a partial view in partial axial cross-section of a transmission element according to the invention;

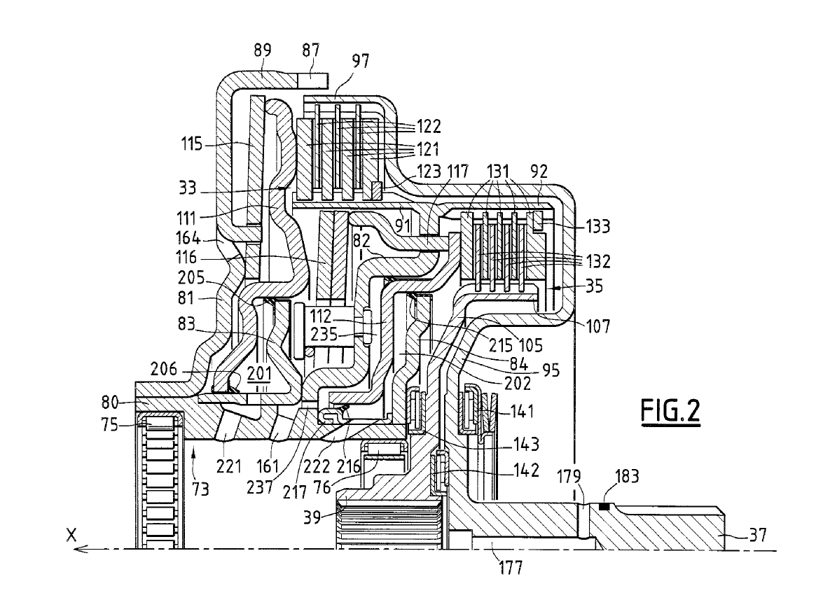

FIG. 2 is a view of a detail of FIG. 1, at a larger scale, which shows a module of the transmission element, comprising essentially the clutches, the input and output shafts, the intermediate member, and the pistons; and

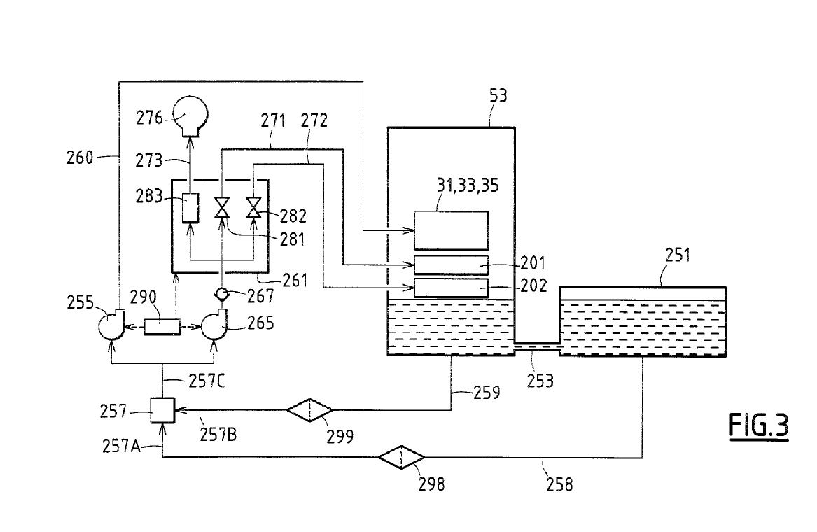

FIG. 3 is a flow chart of the hydraulic control circuit, and of the hydraulic cooling and lubrication circuit of the transmission element of FIGS. 1 and 2.

FIGS. 1 and 2 show a transmission element 25 conform to the invention, intended to connect a thermal engine to a gear box. The element 25 of the invention comprises an electrical machine 31, which will be called “electric motor,” a first clutch 33, and a second clutch 35.

The transmission element 25 comprises further coaxial movement input shaft 37 and movement output shaft 39 having an axis X. The axis X is oriented from the input toward the output to facilitate the following description.

The terms “upstream” and “downstream” have a meaning in reference to this orientation.

The input shaft 37 is integral in rotation with the crankshaft of the thermal engine, of which a portion, or “nose,” is shown on FIG. 1 under reference numeral 41.

In the example shown, the crankshaft 41 is equipped with a flywheel 43, and connected to the input shaft 37 via a damping device 45.

The output shaft 39 is linked in rotation to the primary gear box input shaft, of which a portion is shown on FIG. 1 under reference numeral 47.

The transmission element 25 comprises a casing constituted essentially by a first half-shell 51 and a second half-shell 52, assembled by fixation means distributed over the periphery of the casing and symbolized on FIG. 1 by interrupted lines 54. The casing half-shells 51, 52 delimitate internally a housing 53, inside which are arranged the electric motor 31, the clutches 33, 35, and the input 37 and output 39 shafts, in a coaxial manner.

The input shaft 37 and the output shaft 39 are mounted movable in a rotation with respect to the casing 51, 52.

The input shaft 37 is a fluted shaft complementary to a hollow shaft 55 of the damping device 45, and an end portion of the input shaft 37 protrudes axially from the first half-shell 51. The input shaft 37 is mounted movable in rotation on the first half-shell 51 via a rolling bearing 57.

The output shaft 39 is a hollow shaft with internal flutes, having a shape complementary to the end of the gear box input shaft 47. To be engaged with the output shaft 39, the end of the gear box input shaft 47 protrudes inside the housing 53.

The electric motor 31 comprises a stator 61, equipped with a collector, integral with the first casing half-shell 51, and a rotor 63 mounted movable in rotation on the first half-shell 51 via a bearing 65. The rotor 63 is arranged radially inside the stator 61.

The first 33 and second 35 clutches are of the wet type, and the transmission element 25 is equipped with an axial tube 71 for distribution of lubrication and cooling fluid as well as for control. This tube 71 protrudes inside the housing 53 of the second casing half-shell 52.

The transmission element 25 has an intermediate transmission member 73 mounted movable in rotation on the tube 71, radially outside, via two bearings 75, 76.

The intermediate member 73 is formed essentially with a hub 80, and four radial walls 81, 82, 83, 84, shifted axially with respect to each other, and made integral with the hub 80 by welding for walls 81, 82, 84, and by hooping for wall 83.

The intermediate member 73 is linked in rotation with the rotor 63 via complementary axial teeth 87 which are mutually engaged, and formed on a peripheral portion of the rotor 63 and on a peripheral portion of the first radial wall 81, respectively.

The second radial wall 82 is formed with an integral peripheral ring constituted by a first half-ring 91 extending in the downstream axial direction, and a second half-ring 92 extending in the upstream axial direction.

Correspondingly, the input shaft 37 is formed, preferably in one piece, with a radial wall 95 which extends inside the housing 53, and which has at its periphery an axial ring 97. The axial ring 97 extends in a coaxial and radially external manner, with respect to the downstream half-ring 91. The first clutch 33 is arranged between said half-ring 91 and said ring 97.

In the same manner, the output shaft 39 is formed, preferably in one piece, with a radial wall 105 which extends inside the housing 53, and which has at its periphery an axial ring 107. The axial ring 107 extends in a coaxial and radially external manner, with respect to the upstream half-ring 92 of the intermediate member 73. The second clutch 35 is arranged between said half-ring 92 and said axial ring 107.

The transmission element 25 comprises further a first actuating piston 111 and a second actuating piston 112 of the first clutch 33 and of the second clutch 35, respectively, as well as a first spring member 115 and a second spring member 116 acting on the first piston 111 and on the second piston 112, respectively, toward pressing on the respective clutch 33, 35.

Between the piston 112 and the spring member 116 is interposed, supported axially, a spacer having essentially axial fingers 117 distributed on the periphery of a ring. These fingers 117 pass through the wall 82.

The first clutch 33 is essentially constituted by a first series of discs 121 linked in rotation to the first half-ring 91 by flutes, and movable axially on the latter, along these flutes, under the action of piston 111; and of a second series of discs 122 linked in rotation to the axial ring 97 by flutes, and movable axially on the latter, along these flutes also under the effect of piston 111. The first discs 121 and the second discs 122 are interleaved with each other in an alternating manner.

The discs 121, 122 are stopped axially by a stop 123 opposed to the piston 111.

It is observed that the discs 121, 122 can pass from an unclutched position, in which the first discs 121 are not in contact with the second discs 122, and an engaged position of the first discs 121 and second discs 122, in which the first discs 121 and second discs 122 are pressed against each other.

In the unclutched position, the input shaft 37 and the intermediate member 73 are free in rotation with respect to each other.

The first spring member 115, constituted in the example shown by a spring-washer, for example, of the Belleville washer type, is fixed to the first radial wall 81, and acts on the piston 111 in the engaged position.

The second clutch 35 has a constitution and operation analogous to the first: it comprises a first series of discs 131 associated to the second half-ring 92, and a second series of interleaved discs 132, associated to the axial ring 107. The axial movement of the discs 131, 132 is limited by a stop 133.

In the example shown, the spring member 116 is a double spring washer, of the Belleville type, fixed to the second wall 82. The spring member 116 acts on the piston 112 toward the engaged position of the second clutch 35, via fingers 117.

As is visible on FIG. 1, the two clutches 33, 35 are shifted axially and radially according to a tiered or “stepped” arrangement, i.e., the first clutch 33 is disposed radially outside with respect to the second clutch 35. The latter is arranged inside the rotor 63.

The transmission element 25 is further equipped with needle stops, among which a first one 141 is interposed axially between the bearing 65 and the radial wall 95 of the input shaft 37; a second one 142 is interposed axially between the radial wall 95 and the radial wall 105 of the output shaft 39; a third one 143 is interposed between the radial wall 105 and the radial wall 84 of the intermediate member 73; and a fourth one 144 is interposed between the hub 80 and a shoulder of the tube 71.

The fluid distribution tube 71 is adapted to distribute lubrication and cooling fluid inside the transmission element 25, i.e., inside the housing 53. The latter is sealed against this fluid, in particular in the area of the jointing of the two casing half-shells 51, 52, by means of a peripheral seal 150.

In the vicinity of the axis X, the sealing of the transmission element 25 against the lubrication and cooling fluid is obtained, on the one hand, by a first lip seal 181, which is supported on the first half-shell 51 and the outside surface of the hollow shaft 55, and by a second lip seal 182, which is supported on the inside surface of the tube 71 and on the outside surfaces of the primary gear box input shaft 47, and on the other hand, by an O-ring 183 placed between the input shaft 37 and the hollow shaft 55.

This tube 71 has, provided in its wall, a first fluid supply radial channel 151, a first distribution axial channel 153 connected to said supply channel 151, an orifice 155 provided between the distribution channel 153 and the outside of the tube 71, and an orifice 157 provided between the distribution channel 153 and the inside of the tube.

The hub 80 of the intermediate member 73 is equipped with a channel 161 opening onto the orifice 155, and setting in communication the distribution channel 153 and the housing 53.

In operation, the supply channel 151 is connected to a circuit, which will be described below, for the supply of cooling and lubrication fluid. This fluid is diffused inside the housing 53 via the distribution channel 153, the orifice 155, and the channel 161, so as to lubricate and cool the first clutch 33, the second clutch 35, and the electric motor 31.

It will be noted that the lubrication and cooling fluid is diffused radially toward the stator 61, thanks in particular to the passage 163 provided in the area of the teeth 87. The dimensioning of this passage 163 makes it possible to control the fluid flow rate organized between the portion of the housing 53 internal to the rotor 63, and the external portion in which the stator 61 is arranged.

It will also be noted that the relative disposition of the clutches 33, 35, and of the electric motor 31 makes it possible, due to the centrifugation of the lubrication and cooling fluid, to keep the first clutch 33 in a bath of lubrication and cooling fluid, during operation of the transmission element 25, whereas the area of the second clutch 35 is the seat of a mist of this same fluid. The interest of this disposition is to adapt the amount of fluid, present in the area of each clutch, in particular the calorific energy generated by these clutches.

The bath of fluid, in general, oil, in which the clutch 33 is maintained, is leveled thanks to a passage 164 in the area of the radial wall 81.

The first clutch 33 being subjected to heating more importantly than the second clutch 35, it is indeed necessary to organize, in the vicinity of first clutch, a markedly higher flow rate of cooling fluid.

The more important heating of the clutch 33, as compared to the clutch 35, is due to slipping phases, which are more constraining for the first than for the second. Further, maintaining the clutch 35 in a mist of fluid, rather than in a bath, makes it possible to reduce the drag forces of this fluid on the primary gear box shaft.

Further, the cooling and lubrication fluid is distributed toward the rolling bearing 57 and the bearing 65 to cool and lubricate the latter, via, successively: the distribution channel 153; the orifice 157; a radial passage 171 formed in the primary gear box input shaft 47; an axial channel 172 provided in this shaft; a nozzle 175 making it possible to adjust the fluid flow rate; an axial channel 177 formed in the input shaft 37; and, finally, a radial passage 179 opening in the vicinity of the rolling bearing 57.

The fluid distributed along this path flows into the housing 53, through the rolling bearing 57, toward the bearing 65 and the rotor 63, then toward the stator 61. The stator 61 and the rotor 63 are thus cooled and lubricated, not only by fluid which has transited via the orifice 155 and the passages 163, 164, but also by fluid which has transited via the orifice 157 and the path detailed previously. This fluid also makes it possible to lubricate the stops 141, 142, 143.

The dispositions that make it possible to move the pressure pistons or plates 111, 112, and thus to move the clutches 33, 35 from a position to another among their engaged and unclutched positions, will now be described.

The first piston 111 defines, with the third radial wall 83 and the outside surface of the hub 80, a first pressure chamber 201, while the second piston 112 defines, with the fourth radial wall 84 and the outside surface of the hub 80, a second pressure chamber 202.

The first pressure chamber 201 is substantially sealed with respect to a control fluid by means of a lip seal 205 fixed in the periphery of the radial wall 83, and applied on a surface of the piston 111, and of a lip seal 206 fixed on a radially internal edge of the piston 111, and applied on the outside surface of the hub 80.

In an analogous manner, the pressure chamber 202 is substantially sealed by a first seal 215 applied on the radial wall 84 and the piston 112, and by a second lip seal 216 applied on the piston 112 and the outside surface of a part 217 arranged on the hub 80.

Each pressure chamber 201, 202 opens into the central bore of the hub 80 via two channels 221, 222, respectively, for the passage of the control fluid supply, formed in the hub 80.

The fluid distribution tube 71 is itself equipped with two channels 231, 232, connected to a control fluid supply circuit via respective radial supply channels (not shown) analogous to the channel 151, and respective axial distribution channels (not shown) analogous to the channel 153. The channels 231, 232, communicate with the passages 221, 222, respectively.

In the example shown, the control fluid is the same as the lubrication/cooling fluid, the control and lubrication/cooling circuits being partially common.

It is observed that, from an initially closed position of the clutch 33, 35, the passage to the unclutched position is obtained by supplying the respective pressure chamber 201, 202 with pressurized control fluid. The corresponding piston 111, 112 is then moved axially in the downstream direction, according to the orientation of the axis X (toward the left on FIG. 2), while compressing the spring member 115, 116 and releasing the piles of discs 121, 122, 131, 132.

Under the action of the spring 115, 116, the piston 111, 112 goes back to its initial position when the pressure of the control fluid in the respective pressure chamber 201, 202 is brought back to its low initial value. The clutch 33, 35 goes back then to its so-called “naturally closed,” i.e., engaged, position, in the absence of a supply of the pressure chamber 201, 202 with control fluid.

It is observed that the two clutches 33, 35 can be operated independently, and that the description above relative to the operation of the clutches 33, 35 applies to one or the other independently.

Further, the pressure of control fluid which can be delivered to the pressure chambers 201, 202 can vary over a range of values, such that the corresponding clutch 33, 35 can be brought in one among zero (unclutched), total (engaged), or partial (sliding) transmission states.

It must be observed that the second radial wall 82 and the piston 112 define between them a compensation chamber 235, located on the side opposite the second pressure chamber 202 with respect to the piston 112. This compensation chamber 235 is supplied with lubrication and cooling fluid via the channel 161 and an orifice 237 provided in the radial wall 82. Thus, at high engine speed, the additional forces generated on the piston 112 by the centrifugation of the control fluid contained in the second pressure chamber 202 are compensated, and the piston 112 operates so as to allow the passage, between the discs 131, 132, of the torque for which it has been dimensioned. It can also be noted that the dimensioning of the clutch 33, of the piston 111, and of the spring 115, makes it possible to avoid a compensation chamber for the control of this clutch 33.

In reference to FIG. 3, the hydraulic control circuit of the clutches 33, 35, and the hydraulic cooling and lubrication circuit of the transmission element 25, will now be described.

The lubrication and cooling circuit comprises a lubrication and cooling chamber constituted, in the example shown, by the housing 53 in which are provided, on the one hand, the electric motor 31 and the clutches 33, 35, and on the other hand, the two pressure chambers 201, 202 substantially sealed with respect to the lubrication and cooling fluid contained in the chamber 53. Actually, the seals 205, 206, 215, 216 do not ensure a perfect sealing and let the fluid used to move the pistons 111, 112 flow, at a very low flow rate, into the housing 53, so that the fluid used for the control circuit is mixed in the housing 53 with the fluid used for the lubrication and cooling circuit.

Thus, the control circuit of the clutches 33, 35 uses the same fluid as the lubrication and cooling circuit, and has a common portion with the latter. The control circuit, and in particular said common portion, will be described below.

The lubrication and cooling circuit comprises further a tank 251 of fluid and a discharge channel 253, via which an output of the chamber 53 and an input of the tank, constituting a fluid recirculation input, are connected.

The lubrication and cooling circuit comprises further a first pump 255, and a thermostatic valve 257 with two inputs 257A, 257B and an output 257C. The pump 255 is of the low pressure and high flow rate type.

The first input 257A of the thermostatic valve 257 is connected to an output of the tank 251 via a main supply channel 258, while the second input 257B is connected to an output of the lubrication and cooling chamber 53 via a recycling channel 259.

The output 257C is connected to the input of the pump 255.

The output of the pump 255 communicates with the lubrication and cooling chamber 53 via a lubrication and cooling channel 260, making it possible to bring lubrication and cooling fluid into the vicinity of the movable mechanical parts of the electric motor 31 and of the clutches 33, 35.

The control circuit of the clutches 33, 35 has a distribution block 261 and a second pump 265, whose input is connected to the output 257C of the thermostatic valve 257, and whose output is connected to the distribution block 261 via a check valve 267. The pump 265 is of the high pressure and low flow rate type.

The distribution block 261 comprises a first output path 271 connected to the first distribution chamber 201, and a second output path 272 connected to the second pressure chamber 202. In the example shown, the distribution block 261 is also equipped with a third input/output path 273, connected to a pressure accumulator 276 of the control circuit.

The distribution block 261 comprises, for each path 271-273, a respective electrovalve 281-283 making it possible to close or open selectively, optionally partially, the path to which it is assigned.

In the example shown:
the first 281 and second 282 electrovalves assigned to the first 271 and second 272 output paths, respectively, are of the “proportional” type. These electrovalves can take several intermediary positions between extreme, completely open and completely closed, positions, as a function of a control signal; and the third electrovalve 283 assigned to the third input/output path 273 is of the “on/off” type.

The low pressure pump 255 of the lubrication and cooling circuit, and the high pressure pump 265 of the control circuit, as well as the electrovalves 281-283 of the distribution block 261, can be driven by a centralized control unit 290.

It will be noted that the main supply channel 258 and the recycling channel 259 are preferably equipped each with a respective filtration element (or strainer) 298, 299.

As indicated above, the control circuit and the lubrication and cooling circuit have a common portion including essentially, in the example shown, the tank 251, the main supply channel 258, the recycling channel 259, and the thermostatic valve 257.

In operation, the low pressure pump 255 is capable of providing to the lubrication and cooling chamber 53 pressurized fluid coming from the tank 251 and/or the lubrication and cooling chamber 53 via the recycling channel 259, as a function of the state of the thermostatic valve 257. It has already been described in reference to FIGS. 1 and 2 how the fluid used for lubrication and cooling can circulate inside the housing 53 to reach the receptive parts, constituted by the electrical machine 31 and the clutches 33, 35, and more specifically, by the housing 53 and the pressure chambers 201, 202.

As shown on FIG. 3, this fluid is set in circulation via the discharge channel 253 toward the tank 251, or via the recycling channel 259.

As indicated previously, the fluid distributed to the pressure chambers 201, 202, flows itself involuntarily into the housing 53 due to unavoidable leaks in the area of the seals 205, 206, 215, 216. The flows of fluid having performed a cycle, be it for lubrication/cooling or for clutch control, are thus mixed again in the housing 53.

The tank 251 serves as a heat exchanger and makes it possible for the fluid contained therein to be cooled, when the fluid reaches a temperature above the ambient temperature or a given equilibrium temperature.

The operation of the thermostatic valve 257 will now be explained.

The thermostatic valve 257 is intended to ensure a constant flow rate at the output 257C, this output flow rate resulting from the sum of the flow rate at the first input 257A and the flow rate at the second input 257B. A function of the thermostatic valve 257 is to adjust the contribution to the output flow rate of each of said inputs, as a function of the temperature of the fluid transiting in the valve. Thus, the thermostatic valve 257 selects the origin of the fluid which is delivered to the receptive parts 53, 201, 202, among the main supply channel 258 and the recycling channel 259.

The principle of a thermostatic valve is known and will not be described in details in the present application. It will be indicated only that a thermostatic valve comprises, in a standard manner, inside a valve body, a sensitive part forming a wall whose position depends on its temperature.

More precisely, in the embodiment of the invention described here, the thermostatic valve 257 operates in the following manner: over a range of operating temperatures, the sensitive element of the thermostatic valve 257 moves or is deformed so as to modify the passage cross-section of each of the inputs 257A, 257B, and this, in a complementary manner, i.e., so as to keep the flow rate at the output 257C constant. The thermostatic valve 257 operates so that the free passage cross-section of the first input 257A, over the operating temperature range, increases with the temperature, according to a law that can be, for example, linear. In a complementary manner, over this same temperature range, the free passage cross-section of the sensitive element of the second input 257B increases when the temperature of the sensitive element, i.e., the temperature of the fluid transiting via the thermostatic valve 257, decreases.

In a first extreme position corresponding to the lower threshold temperature of the operating temperature range, the sensitive element of the thermostatic valve 257 can completely close the first input 257A and completely free the second input 257B.

Conversely, for a temperature above the upper threshold temperature of the temperature range, the sensitive element can completely close the second input 257B and completely free the first input 257A. This case corresponds to a second extreme position.

The first of these extreme cases corresponds, for example, to transitory conditions for a cold start, in which the fluid temperature must be quickly raised, to reach an optimal effectiveness of the fluid.

In contrast, the second extreme case corresponds to permanent operation phases, in which the fluid has reached its optimal operating temperature.

It is observed that, when the second input is partially open, fluid that has transited in the lubrication and/or cooling circuit is recycled via the recycling channel 259, and directly reintroduced into one or the other of the lubrication and/or cooling circuit and the control circuit, so that the fluid is practically not let to rest in the tank 251 for cooling. Fluid that has not been cooled, coming from the recycling channel 259, is then mixed, with a more or less important dilution rate, to cooled fluid coming from the tank 251.

1. Transmission element for a traction chain of the parallel hybrid type, said element comprising a movement input shaft intended to be connected to a thermal engine, a movement output shaft intended to be connected to a gear box, an electrical machine comprising a stator and a rotor, a first connecting clutch between the input shaft and the rotor, and a second connecting clutch between the rotor and the output shaft, said clutches being of the wet type, said transmission element further comprising a circuit of lubrication and/or cooling fluid, which comprises a lubrication and/or cooling chamber of the clutches and of the electrical machine, a tank of lubrication and/or cooling fluid, and at least one pump connected, on the one hand, to said tank, and on the other hand, to said chamber, wherein said pump is further connected to a recycling channel of said chamber, the lubrication and/or cooling circuit comprising selection means placed upstream of the pump, so that said pump is capable of supplying said chamber with pressurized fluid selectively from the tank and from the recycling channel, as a function of the temperature of the fluid transiting via the selection means.

2. Transmission element according to claim 1, wherein the selection means have two fluid inputs, among which a first input is connected to the tank and the second input is connected to the recycling channel, and a fluid output connected to the pump, the selection means operating such that, in operation of the transmission element,
the total flow rate of fluid transiting via the output of the selection means is substantially constant, and
over a temperature range of the fluid transiting via the selection means, comprised between a lower threshold value and an upper threshold value, the flow rate of fluid coming from the second input increases when the temperature decreases.

3. Transmission element according to claim 2, wherein the selection means comprise a thermostatic valve.

4. Transmission element according to claim 1, wherein the lubrication and/or cooling chamber of the clutches constitutes also a lubrication and/or cooling chamber of the electric motor, so that the lubrication and/or cooling circuit of the clutches constitutes also a lubrication and/or cooling circuit of the electric motor.

5. Transmission element according to claim 1, further comprising control means of said clutches, which comprise a hydraulic control circuit including a pressure chamber for each clutch, such that the pressure of control fluid which prevails in the pressure chamber determines the state of the respective clutch, wherein the control fluid is constituted by the lubrication and/or cooling fluid, the control circuit and the lubrication and/or cooling circuit having in common at least said tank, said recycling channel, and said selection means.

6. Transmission element according to claim 5, wherein the hydraulic control circuit comprises a distribution block connected to the pump downstream of the latter and adapted to distribute the fluid to the pressure chambers.

7. Transmission element according to claim 6, wherein said control circuit comprises a pressure accumulator, and the distribution block comprises an input/output path connected to said accumulator, and a charge/discharge electrovalve assigned to said output/input path.

8. Transmission element according to claim 6, wherein the distribution block comprises a control output path for each pressure chamber, and a respective electrovalve for control of the control flow rate, assigned to each of said control paths.

9. Transmission element according to claim 6, wherein said control electrovalves are of the proportional type.

10. Transmission element according to claim 1, which comprises a second pump, connected, upstream, to the output of the selection means, and downstream, via a lubrication and/or cooling output path, to the lubrication and/or cooling chamber.

11. Method of lubricating and/or cooling clutches of a transmission element according to claim 1, which comprises, in operation of the transmission element,
supplying the lubrication and/or cooling chamber with a total flow rate of fluid at the output of the selection means resulting from a first flow rate of fluid coming from the first input and a second flow rate of fluid coming from the second input, such that said first and second flow rates are determined as a function of the temperature of the fluid transiting via the selection means.

12. Method according to claim 11, wherein
the total flow rate of fluid transiting via the output of the selection means is substantially constant, and
over a temperature range of the fluid transiting via the selection means, comprised between a lower threshold value and an upper threshold value, the flow rate of fluid coming from the second input increases when the temperature decreases.

13. Method of lubricating and/or cooling and of controlling clutches of a transmission element according to claim 1, which comprises, in operation of the transmission element,
supplying the lubrication and/or cooling chamber, and optionally, the pressure chambers, with a total flow rate of fluid at the output of the selection means resulting from a first flow rate of fluid coming from the first input and a second flow rate of fluid coming from the second input, such that said first and second flow rates are determined as a function of the temperature of the fluid transiting via the selection means.

14. Method according to claim 13, wherein
the total flow rate of fluid transiting via the output of the selection means is substantially constant, and
over a temperature range of the fluid transiting via the selection means, comprised between a lower threshold value and an upper threshold value, the flow rate of fluid coming from the second input increases when the temperature decreases.

15. Motor vehicle comprising a transmission element according to claim 1.
